(19) United States
(12) Patent Application Publication
(10) Pub. No.: US 2013/0044223 A1
(43) Pub. Date: Feb. 21, 2013

(54) METHOD FOR TESTING AN IMAGE CAPTURING DEVICE

(71) Applicants: Yi-Ju Chen, Taoyuan (TW); Ching-Feng Hsieh, Taipei (TW)

(72) Inventors: Yi-Ju Chen, Taoyuan (TW); Ching-Feng Hsieh, Taipei (TW)

(73) Assignees: ASKEY COMPUTER CORPORATION, Taipei (TW); ASKEY TECHNOLOGY (JIANGSU) LTD., Wujiang (CN)

(21) Appl. No.: 13/292,606

(22) Filed: Nov. 9, 2011

(30) Foreign Application Priority Data
Aug. 19, 2011 (TW) 100129705

(51) Int. Cl. H04N 17/02

(52) U.S. Cl. 348/187; 348/E17.002

(57) ABSTRACT

A method for testing an image capturing device with quality parameters includes providing a predetermined criteria for the variations in images and quality parameters corresponding to a specific target-object, capturing a test image corresponding to the same target object by an image capturing device to be tested, and retrieving a standardized image and a test image located at the same position by a standard image unit and a test image unit, respectively, thereby comparing quality parameters of the standard image unit and the test image unit on the same position to accurately detect and determine any abnormity in the image capturing device.

### BACKGROUND OF THE APPLICATION

1. Field of the Application The application relates to a method for testing an image capturing device, and, more particularly, to a method for testing whether the image capturing device is abnormal by using quality parameters.

2. Background

Whatever kind of electronic devices, before being manufactured and sold or being installed in a system, need functional test to eliminate those under abnormal status, and along with popularization, miniaturization and versatility of image capturing device, fast and accurate functional test is increasingly important.

Most of the current test processes specialized on an image capturing device depend are tested manually. In an actual test, a test staff first uses related control devices to allow the image capturing device to be tested to capture and obtain a test image. The test image is tested for distortion or defocus, depending on the personal subjective experience and examination by naked eye to judge whether the function of image capturing device is abnormal.

However, method for testing a image capturing device depending on manual examination not only tends to misjudge and further affect yield rate, but also tends to be limited to limitation of speed of manual operation unable to test fast and further delay availability of goods and assembly process.

Furthermore, because personal subjective experience is unable to induct an uniform and objective judging standard. Thus, although abnormal image capturing device can be discovered correctly, maintenance staff, upstream firms and downstream firms can't realize where the problem is.

### SUMMARY OF THE APPLICATION

In view of disadvantages of testing image capturing device by manual examination, one of the major purposes of this application lies in providing a test process solving the error of manual examination.

To achieve the purpose and other purposes, thus application provides a method for test an image capturing device, including the following steps: providing a standardized image corresponding to a specific target-object and a predetermined standard of a difference between quality parameters;

utilizing an image capturing device to capture a test image corresponding to identical specific target-object;

retrieving a plurality of standard image units and test image units at the same position from the standardized image and the test image, respectively; and comparing quality parameters of the standard image unit and test image unit at the same position, when the number of a difference between the standard image unit and test image unit exceeds the predetermined standard, judging the image capturing device as abnormality.

In an embodiment, the standard image unit and test image unit can be located at specific points or areas, and the specific points or areas can be located at the critical boundary of the standardized image and the test image. Besides, retrieving a single or a plurality of standard image unit(s) and test image unit(s) at the same position can be retrieving single or a plurality of standard image unit(s) and test image unit(s) at the same coordinates, and actual implementation of this application is able to be implemented by related automation equipment matched with test software.

Compared to current test technology of examining image capture device by manual examination, because thus application utilizes quality parameters to compare standard image unit of standardized image and test image unit of test image at same position and can be realized by automation equipment matched with test software. Thus, this application can not only solve the problem of error generated by manual examination, but also examine function of image capturing device with uniform judging standard, so the disadvantages in prior art can be avoided.

### BRIEF DESCRIPTION OF DRAWINGS

FIG. 1 is a flow chart of a method for testing an image capturing device of a first embodiment according to the present invention;

FIG. 2 is flow chart of a method for testing an image capturing device of a second embodiment according to the present invention;

FIG. 3 shows quality parameters analyzed from a standard image unit by capturing a standard image unit from a standardized image; and

FIG. 4 shows quality parameters analyzed from a test image unit by a capturing test image unit from a test image.

### DETAILED DESCRIPTION OF PREFERRED EMBODIMENTS

The following explains this application by specific embodiments, whoever has ordinary knowledge in the technical field of this application can easily understand advantages and efficacy of the application from the specification.

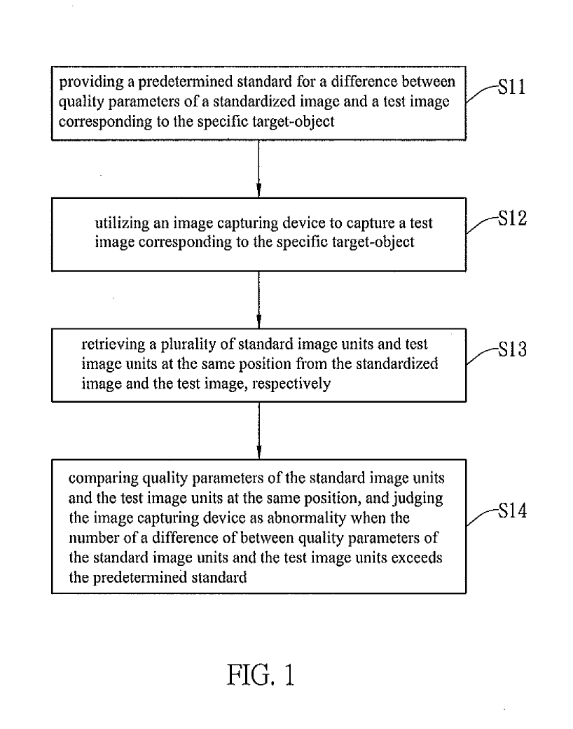

FIG. 1 shows a flow chart of a method for test an image capturing device of a first embodiment according to the present invention. Notice that the method for test an image capturing device provided according to the present invention can be implemented by related automation equipment matched with test software.

Step S11 provides a predetermined standard of a difference between a standardized image and quality parameters corresponding to a specific target-object, and then enters step S12. In an embodiment, the specific target-object can be an object or picture with an obvious color-level difference, and the standardized image is the comparison standard for testing image capturing device to be tested.

Step S12 utilizes a testing image capturing device to be tested to capture a test image corresponding to identical specific target-object, and then enters step S13. In an embodiment, step S11 and step S12 can be optionally implemented at the same time for coping with different test environments.

Step S13 retrieves a plurality of standard image units and test image units at the same position from the standardized image and the test image, respectively, and then enters step S14. In an embodiment, the standard image unit and test image unit are located at specific points or areas in the standardized image and the test image, respectively, and the specific points or areas can be located at a critical boundary of an image in the standardized image and the test image.

In detail, if a specific target-object is a picture with an obvious color-level difference, then pictures belong to a standardized image and test image have an obvious color-level difference likewise, and meanwhile the specific points or areas can be set on the critical boundary of an image in a different color-level. Retrieving a plurality of standard image units and test image units at the same position can be implemented by coordinates, that is, retrieving a plurality of standard image units and test image units with same coordinates.

Step S14 compares quality parameters of a standard image unit and a test image unit at the same position, judging the image capturing device as abnormality when the difference of quality parameters between a standard image unit and a test image unit exceeds the predetermined standard. In an embodiment, the quality parameter can correspond to, but are not limited to, resolution, luminance or color.

In detail, if there are ten standard image units and test image units retrieved and the predetermined standard can be set as 50%, under this standard, after comparing all quality parameters of standard image units and test image units at the same position. If there are over five standard image units and test image units has different quality parameters, then further judge the function of image capturing device as abnormality. Of course, the predetermined standard can be adjusted corresponding to different considerations of cost or requirements from manufacturers. Because the standard image unit and test image unit can be located on the critical boundary of an image, abnormality such as distortion and defocusing can be judged much faster.

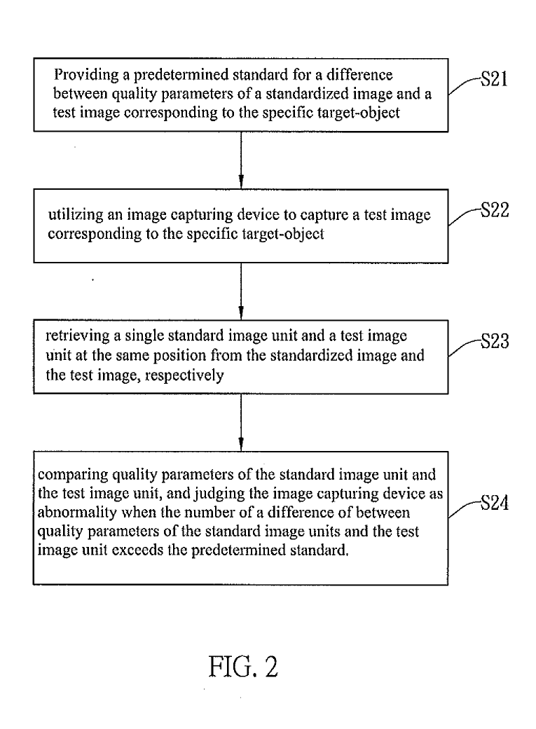

FIG. 2 shows a flow chart of a method for testing an image capturing device in a second embodiment according to the present invention. Notice that step S21 and step S22 in FIG. 2 are the same as step S11 and step S12 in FIG. 2, further description hereby omitted.

Step S23 retrieves a single standard image unit and a test image unit from a standardized image and a test image, respectively, and then enters step S24. In short, step S23 is not necessary to retrieve a plurality of standard image units and test image units at the same position like step S13.

Where step S23 and step S13 in common lies in standard image unit and test image unit can likewise and respectively be locate at specific points or areas, and the specific points or areas can likewise be located on the critical boundary of an image in the standardized image and the test image.

Step S24 compares quality parameters of the standard image unit and test image unit, and judges the image capturing device as abnormality when the difference of quality parameters between the standard image unit and test image unit exceeds the predetermined standard.

For example, presume that predetermined standard is ten units of quality parameters, the image capturing device can be judged as abnormality when the difference of quality parameters between a standard image unit and a test image unit exceeds ten units of quality parameters. The quality parameter can likewise correspond to, but are not limited to, resolution, luminance or color.

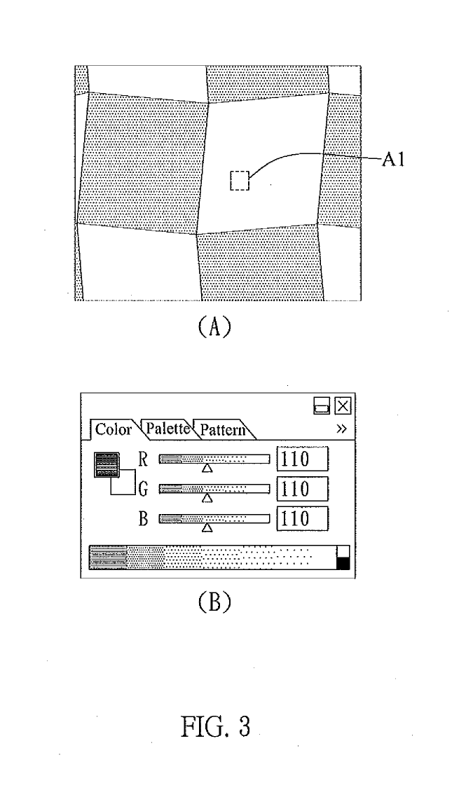

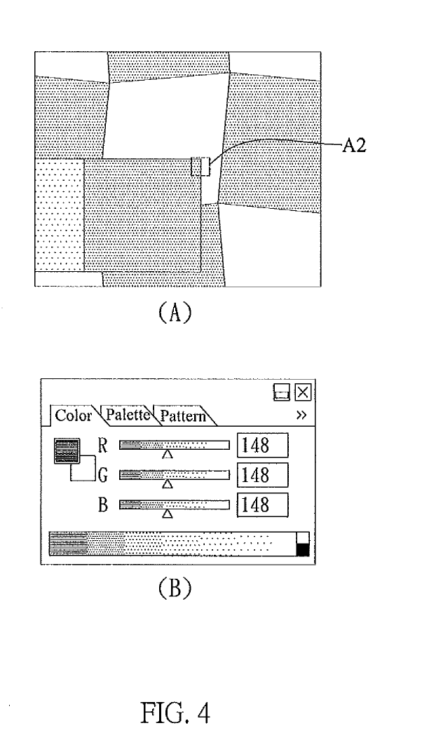

For further understanding of the method for testing an image capturing device, please refer to FIG. 3 together with FIG. 4. FIG. 3 shows quality parameters analyzed from a standard image unit by a capturing standard image unit from a standardized image. FIG. 4 shows quality parameters analyzed from a test image unit by capturing a test image unit from a test image.

In FIG. 3(A), the image with a white area (W) and a black area (B) is a standard image, and a standard image unit A1 is located within the white area (W). As illustrated in FIG. 3(B), a standard image unit A1 is analyzed as three primary colors “110,110,110,” that is, quality parameters corresponding to color are analyzed.

In FIG. 4(A), the image with a white area (W), a black area (B) and a gray area (G) is a test image, and a test image unit A2 is located on the critical boundary of an image between the white area (W) and the black area (B), wherein the position of test image unit A2 is the same as that of the standard image unit A1. As illustrated in FIG. 4(B), a test image unit A2 is analyzed as three primary colors “148,148,148,” that is, quality parameters corresponding to color are analyzed.

For example, presume that a predetermined standard is set as ten units of quality parameters, meanwhile because quality parameters of a test image unit A2 corresponding to color exceeds quality parameters of a standard image unit A1 corresponding to color by ten units of quality parameters, such as 148+148+148−110−110−110>10, thus, an image capturing device is judged as abnormality. Of course, a plurality of standard image units A1 and test image units A2 by ten can be respectively captured, and a predetermined standard is set that an image capturing device is judged as abnormality when the difference of a number of parameters between a standard image unit A1 and a test image unit A2 exceeds five.

To sum up, because this application can utilize quality parameters to compare a single or a plurality of standard image unit(s) and test image unit(s) at the same position in the standardized image and test image, actually implementing operation by automation equipment matched with test software. Thus, this application can not only implement test process for image capturing device fast and correctly, but also examine the function of image capturing device with uniform and objective judging standard. Compared to current test technology for image capturing device by manual examination, this application avoid disadvantages of typically occurred misjudgment, tending to delay process and that no uniform and objective judging standard can be inducted.

However, method for testing image capturing device depending on manual examination, not only tends to misjudge and further affect yield rate, but also tends to be limited to limitation of speed of manual operation unable to test fast and further delay availability of goods and assembly process.

Furthermore, because personal subjective experience is unable to induct an uniform and objective judging standard. Thus, although abnormal image capturing device can be discovered correctly, maintenance staff, upstream firms and downstream firms cannot realize where the problem is.

The embodiments are only illustratively explain the theory and efficacy of this application rather than limiting this application. Whoever has ordinary knowledge in the technical field of this application can modify or alter the application without violation of the spirit and scope in the application. Thus, rights protection of the application should be listed as the following claims.

1. A method for testing an image capturing device, comprising the following steps of:
(1) providing a standardized image corresponding to a specific target-object and predetermined standard of a difference between quality parameters;
(2) utilizing an image capturing device to capture a test image corresponding to identical specific target-object;
(3) retrieving a plurality of standard image units and test image units at the same position from the standardized image and the test image; and
(4) comparing quality parameters of the standard image unit and test image unit at the same position, when the number of differences between the standard image unit and test image unit exceeds the predetermined standard, judging the image capturing device as abnormality.

2. The method of claim 1, wherein the standard image unit and test image unit are located at specific points or areas in the standardized image and the test image, respectively.

3. The method of claim 2, wherein the specific points or areas are located at a critical boundary of an image in the standardized image and the test image.

4. The method of claim 1, wherein in step (3) a plurality of standard image units in the standardized image and test image units in the test image at the same coordinates are retrieved respectively.

5. The method of claim 1, wherein the quality parameters correspond to resolution, luminance and color.

6. A method for testing an image capturing device, comprising the following steps of:
(1) providing a standardized image corresponding to a specific target-object and a predetermined standard of a difference between quality parameters;
(2) utilizing an image capturing device to capture a test image corresponding to identical specific target-object;
(3) retrieving a single standard image unit and test image unit at the same position from the standardized image and the test image, respectively; and
(4) comparing quality parameters of the standard image unit and test image unit at the same position, when the number of differences between the standard image unit and test image unit exceeds the predetermined standard, judging the image capturing device as abnormality.

7. The method of claim 6, wherein the standard image unit and test image unit are located at specific points or areas in the standardized image and the test image, respectively.

8. The method of claim 7, wherein the specific points or areas are located at a critical boundary of an image in the standardized image and the test image.

9. The method of claim 6, wherein in step (3) a single standard image unit in the standardized image and a test image unit in the test image at the same coordinates are retrieved, respectively.

10. The method of claim 6, wherein the quality parameters correspond to resolution, luminance and color.
